(19) United States
(12) Patent Application Publication
(10) Pub. No.: US 2017/0161322 A1
(43) Pub. Date: Jun. 8, 2017

(54) Method and electronic device for searching resource

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yiding WANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,027

(22) Filed: Aug. 19, 2016

Related U.S. Application Data
(63) Continuation of application No. PCT/CN2016/089525, filed on Jul. 10, 2016.

(30) Foreign Application Priority Data
Dec. 7, 2015 (CN) 2015108878589

(51) Int. Cl. G06F 17/30; G06N 5/04

(52) U.S. Cl. CPC G06F 17/30424; G06N 5/04

(57) ABSTRACT

A resource searching method and an electronic device are provided, wherein the method includes: a resource search and user intention recognition in a resource database are performed according to an entry entered by a user; and searched resources are sorted according to a result of user intention recognition. By sorting resources of all types (for example, resources like videos, apps, or audios, etc.) relevant to an entry entered by a user, the user can conveniently and quickly find resources that the user needs.

### CROSS-REFERENCE TO RELATED APPLICATIONS

This application is a continuation of PCT application No. PCT/CN2016/089525 submitted on Jul. 10, 2016. The present application claims priority to Chinese Patent Application No. 201510887858.9, filed with the Chinese Patent Office on Dec. 7, 2015, both of which are incorporated herein by reference in its entireties.

### TECHNICAL FIELD

The present disclosure relates to the field of communications technologies, and in particular, to a method and an electronic device for searching resource.

### BACKGROUND

With development of a network, a user can search, on various search engines, for resources that he is interested in, for example, a webpage, a media stream like a video/audio stream, an image, or an application, etc., by means of a keyword search.

However, in prior art, a search is generally a one-way vertical search; for example, there is only an app relevant search in an application store, or there is only a video relevant search in a video player. A user needs to open different search engines to search for different types of resources. In addition, searched resources may be not displayed according to a user's intention. Therefore, a user may highly possibly spend some time before finding resources that he expects in a large quantity of searched resources.

### SUMMARY

Embodiments of the present disclosure provide a resource-searching method. The method includes: performing a resource search and user intention recognition in a resource database according to an entry entered by a user; and sorting searched resources according to a result of the user intention recognition.

An embodiment of the disclosure further provides a non-transitory computer-readable storage medium, which stores computer executable instructions that, when executed by an electronic device, cause the electronic device to perform an above disclosed method.

An embodiment of the disclosure further provides an electronic device, including: at least one processor; and a memory in communication connection with the at least one processor. The memory stores an instruction that can be executed by the at least one processor, and the instruction is executed by the at least one processor, cause the at least one processor to perform any one of disclosed method.

By using the resource-searching method and the electronic device provided in the embodiments of the present disclosure, performing a resource search and user intention recognition in a resource database according to an entry entered by a user, and subsequently sorting searched resources according to a result of the user intention recognition, it can be implemented to sort, according to an intention of the user, all types of resources (for example, resources including videos, apps, audios, etc.) relevant to the entry entered by the user. For example, if the user expects video resources, then video resources may be ranked highest in a large amount of searched resources; in this way, the user can conveniently and quickly find resources that the user needs.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a schematic structural diagram of an exemplary server of an embodiment of the present disclosure;

FIG. 2 is an exemplary flowchart of execution of a processing module of an exemplary server of an embodiment of the present disclosure;

FIG. 3 is an exemplary flowchart of a resource-searching method of an embodiment of the present disclosure; and

FIG. 4 is a schematic structural diagram of hardware of an electronic device for executing a resource searching method provided in an implementation manner of the disclosure.

### DESCRIPTION OF REFERENCE NUMBERS

10 Resource database 20 Processing module 100 Server

### DETAILED DESCRIPTION

The following describes specific implementation manners of the present disclosure in detail with reference to the accompanying drawings. It should be understood that the specific implementation manners described herein are merely used for describing and explaining embodiments of the present disclosure, and are not used to limit the present disclosure.

The following describes the concept of the present disclosure by examples, but it should be understood that these examples are non-limitative examples, and are not intended to limit the protection scope of the present disclosure.

To describe the concept of the present disclosure more clearly, a detailed description is provided by using an exemplary server provided in an embodiment of the present disclosure as an example.

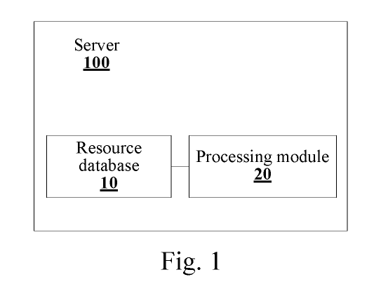

FIG. 1 is a schematic structural diagram of an exemplary server according to an embodiment of the present disclosure. As shown in FIG. 1, the server may include: a resource database 10; and a processing module 20 configured to perform a resource search and user intention recognition in the resource database 10 according to an entry entered by a user and to sort searched resources according to a result of the user intention recognition.

To achieve an objective of this embodiment of the present disclosure, a server 100 first needs to establish the resource database 10 wherein the resource database 10 may include at least one of the following words:

(1) multiple sensitive words and a resource type that corresponds to each sensitive word in the multiple sensitive words, where the sensitive word is a word capable of identifying a resource type; for example, “theatrical version” may be a sensitive word, and a resource type that corresponds to the sensitive word is a video, that is, “theatrical version, video” may be stored in the database 10;

(2) multiple named entities and weight values of multiple resource types that correspond to each named entity in the multiple named entities, where the named entity is an entity with a name as an identifier; for example, “The Journey of Flower” may be a named entity, and the named entity further corresponds to weight values of multiple resource types; for example, a corresponding weight value of a video resource is 5000; a corresponding weight value of an app resource is 2000, and a corresponding weight value of an audio resource is 1500; i.e., “The Journey of Flower, video: 5000, app: 2000, audio: 1500” may be stored in the database 10; for another example, “Empress Wu Zetian” may be a named entity, and the named entity further corresponds to weight values of multiple resource types; for example, a corresponding weight value of a video resource is 6000; a corresponding weight value of an app resource is 1500, and a corresponding weight value of an audio resource is 500; i.e., “Empress Wu Zetian, video: 6000, app: 1500, audio: 500” may be stored in the database 10;

(3) multiple words and weight values of multiple resource types that correspond to each word in the multiple words; for example, “dad” and “mahjong” may be one word separately, and the words separately further correspond to weight values of multiple resource types; i.e., “dad, video: 6000, app: 1200, audio: 3000” and “mahjong, video: 500, app: 2500, audio: 0” may be stored in the database 10. A larger weight value of the foregoing words indicates a higher relevance to a user's intention, and the weight value is obtained according to a TF-IDF (term frequency-inverse document frequency) algorithm; a calculation of the algorithm is similar to that in prior art, and in order not to obscure the protection scope of the present disclosure, details are not described herein again.

It should be understood that examples of the foregoing words and weight values are only used to describe a concept of the present disclosure, and are not used to limit the protection scope of the present disclosure. A person skilled in the art may perform appropriate setting on words and weight values according to an actual situation, and the present disclosure does not limit it. In addition, the resource database provided in the present disclosure optionally includes the foregoing three types of words. However, a person skilled in the art may also select any one of the foregoing three types of words and a combination thereof according to an actual situation.

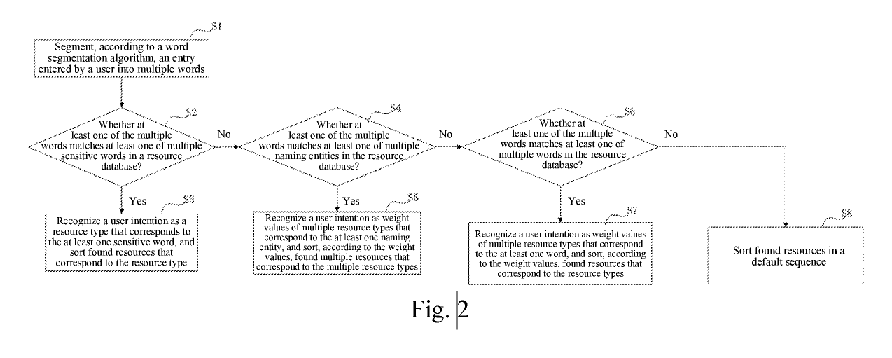

When a user enters an entry by using a client device (for example, a mobile phone, a computer, or a tablet computer, etc.), the processing module 20 of the server may perform a resource search and user intention recognition in the resource database 10 according to the entry entered by the user; and sort searched resources according to a result of the user intention recognition. FIG. 2 is an exemplary flowchart of execution of a processing module of an exemplary server according to an embodiment of the present disclosure, as shown in FIG. 2, wherein specifically:

the processing module 20 first executes step S1, i.e., segmenting, according to a word segmentation algorithm, the entry entered by a user into multiple words, and optionally the word segmentation algorithm may be an appropriate word segmentation algorithm, for example, Friso algorithm, etc., and a calculation of the algorithm is similar to that in prior art, which will not be described herein again to avoid obscuring the protection scope of the present disclosure;

next, because a relevance between the foregoing three types of words and a user's intention is from high to low, to precisely recognize the user's intention, it may be determined first whether at least one of the segmented multiple words matches at least one of multiple sensitive words in the resource database, i.e., executing step S2;

in a case in which at least one of the multiple words matches at least one of the multiple sensitive words in the resource database (that is, in this case, the entry entered by the user includes a sensitive word), a user's intention is recognized as a resource type that corresponds to the at least one sensitive word, that is, executing step S3, and sorted resources can be displayed. When the multiple words respectively correspond to the multiple sensitive words (that is, more than two words find their matching sensitive words in the resource database), the processing module 20 may recognize a user's intention as a resource type that corresponds to a matching sensitive word that is first searched in the resource database, and sort searched resources that correspond to the resource type;

in a case in which the multiple words do not match any one of the sensitive words in the resource database (that is, in this case, the entry entered by the user does not include a sensitive word), step S4 needs to be executed, that is, determining whether at least one of the multiple words matches at least one of named entities in the resource database;

in a case in which at least one of the multiple words matches at least one of the multiple named entities in the resource database (that is, in this case, the entry entered by the user includes a named entity), a user's intention is recognized as weight values of multiple resource types that correspond to the at least one named entity, and searched multiple resources that correspond to the multiple resource types are sorted according to the weight values; that is, executing step S5, and the sorted resources can be displayed. When the multiple words respectively correspond to the multiple named entities (that is, more than two words find their matching named entities in the resource database), the processing module 20 may calculate resource total weight values of these named entities, and recognize a user's intention as weight values of multiple resource types that correspond to a named entity with a maximum resource total weight value, and sort, according to the weight values, the searched multiple resources that correspond to the multiple resource types, where a resource total weight value of a named entity is a sum of weight values of its corresponding multiple resource types;

in a case in which the multiple words do not match any one of the named entities in the resource database (that is, in this case, the entry entered by the user does not include a named entity), step S6 needs to be executed, that is, the processing module 20 needs to determine whether at least one of the multiple words matches at least one of multiple words in the resource database;

in a case in which at least one of the multiple words matches at least one of the multiple words in the resource database, a user's intention is recognized as weight values of multiple resource types that correspond to the at least one word, and searched resources that correspond to the resource types are sorted according to the weight values; that is, executing step S7, and the sorted resources can be displayed. When the multiple words respectively correspond to the multiple words (that is, more than two words find their matching words in the resource database), the processing module 20 may perform weighting on weight values of multiple resource types that correspond to these words, and display resources according to the weighted weight values;

in a case in which the multiple words do not match any one of the words in the resource database (that is, in this case, the entry entered by the user does not include any word), step S8 is executed, sorting searched resources relevant to the multiple words in a default sequence.

The processing module 20 can execute the foregoing steps S1-S8 according to an input of a user, and can display searched resources according to the foregoing sorting, and subsequently release the resources on webpages and push the resources to a client device (for example, a mobile phone, a computer, a tablet computer, etc.). In this way, searched multiple types of resources sorted according to a user's intention can be displayed on a client device.

The following lists some embodiments that may occur in actual use to further illustrate the foregoing concept of the present disclosure. However, it should be understood that these embodiments are only used to describe the concept of the present disclosure, and embodiments of the present disclosure are not limited hereto; for example, a person skilled in the art may set various words and user inputs based on the following embodiments:

### Embodiment 1

A user enters “**theatrical version,” and “theatrical version” in words obtained from word segmentation is a sensitive word. A processing module 20 of a server 100 may execute steps S1-S3, that is, a user's intention is recognized as a video resource. Therefore, after resources are searched, the processing module 20 ranks video resources relevant to “**theatrical version” highest on a list of the searched resources, and pushes the video resources to a client device. When the user enters multiple sensitive words, for example, “theatrical version” and “game” are obtained after word segmentation of an entry entered by the user, if the sensitive word “theatrical version” is matched first, then the processing module 20 may recognize a user's intention as a resource type that corresponds to “theatrical version” in a resource database, and sort searched resources that correspond to the resource type, and vice versa.

### Embodiment 2

A user enters “Episode 5 of The Journey of Flower,” and “The Journey of Flower” in words obtained from word segmentation is a named entity. A processing module 20 of a server 100 may execute steps S1-S5, i.e., recognizing a user's intention as: first, a video resource; second, an app; and third, an audio. Therefore, after resources are searched, the processing module 20 sorts resources relevant to “Episode 5 of The Journey of Flower” in a sequence of videos, apps, and audios, and pushes the resources to a client device. When the user enters multiple named entities, for example, “The Journey of Flower” and “Empress Wu Zetian” are obtained from word segmentation of an entry entered by the user, the processing module 20 may calculate resource total weight values of the two named entities; that is, as described above, weight values of resource types that correspond to The Journey of Flower in a resource database are respectively: video: 5000, app: 2000, audio: 1500, and a resource total weight value is 8500; similarly, weight values of resource types that correspond to Empress Wu Zetian in the resource database are respectively: video: 6000, app: 1500, audio: 500, and a resource total weight value is 8000. Because the resource total weight value of The Journey of Flower is maximum, the processing module 20 recognizes a user's intention as the weight values of the multiple resource types that correspond to The Journey of Flower, and sorts, according to the weight values, searched multiple resources that correspond to the multiple resource types, and vice versa.

### Embodiment 3

A user enters “dad go home,” and “dad” obtained from word segmentation is a word “dad” (in this case, a word “go home” obtained from word segmentation is not a word in a resource database 10). Namely a processing module 20 of a server 100 may execute steps S1-S7, i.e., recognizing a user's intention as weight values that correspond to the word “dad”. That is, the user's intention is recognized as: first, a video resource; second, an app; and third, an audio. Therefore, after resources are searched, the processing module 20 sorts resources relevant to “dad go home” in a sequence of videos, apps, and audios, and pushes the resources to a client device.

### Embodiment 4

A user enters “dad mahjong,” and words “dad” and “mahjong” are obtained from word segmentation. Namely a processing module 20 of a server 100 may execute steps S1-S7, i.e., recognizing a user's intention as weighted values of weight values of the words “dad” and “mahjong.” Namely, the user's intention is recognized as: first, a video resource; second, an app; and third, an audio. Therefore, after resources are searched, the processing module 20 sorts resources relevant to “dad mahjong” in a sequence of videos, apps, and audios, and pushes the resources to a client device.

### Embodiment 5

A user enters “where are you,” and words obtained from word segmentation of the entry are neither sensitive words, or named entities, nor words. Therefore, a processing module 20 of a server 100 may execute steps S1-S8, that is, searched resources are sorted in a default sequence, and are pushed to a client device.

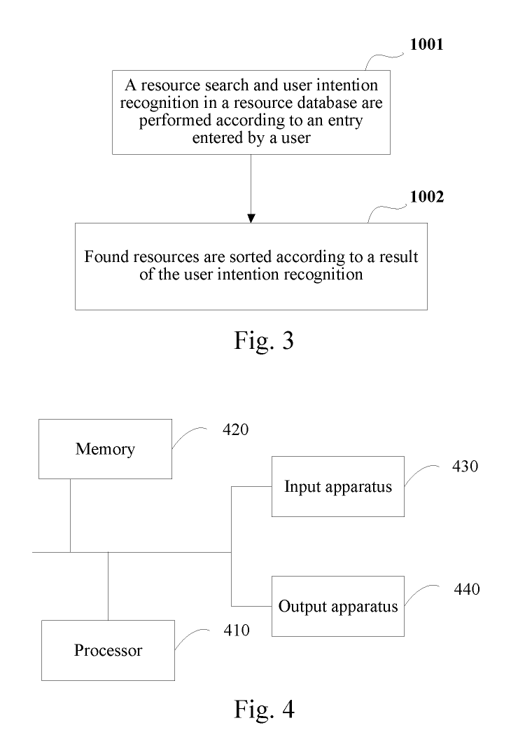

FIG. 3 is an exemplary flowchart of a resource-searching method according to an embodiment of the present disclosure. As shown in FIG. 3, the method may include the following steps:

in step 1001: a resource search and user intention recognition in a resource database are performed according to an entry entered by a user; and

in step 1002: searched resources are sorted according to a result of the user intention recognition.

Optionally, the resource search and user intention recognition in a resource database are performed according to an entry entered by a user includes: segmenting, according to a word segmentation algorithm, the entry entered by the user into multiple words; and the resource search and the user intention recognition are performed according to the multiple words.

Optionally, the resource database includes multiple sensitive words and a resource type that corresponds to each sensitive word in the multiple sensitive words, where the sensitive word is a word capable of identifying a resource type.

Optionally, the searched resources are sorted according to a result of the user intention recognition includes: in a case in which at least one of the multiple words matches at least one of the multiple sensitive words in the resource database, recognizing a user intention as a resource type that corresponds to the at least one sensitive word, and searched resources that correspond to the resource type are sorted.

Optionally, the resource database includes multiple named entities and weight values of multiple resource types that correspond to each named entity in the multiple named entities, where the named entity is an entity that uses a name as an identifier.

Optionally, the searched resources are sorted according to a result of the user intention recognition includes: in a case in which at least one of the multiple words matches at least one of the multiple named entities in the resource database, recognizing a user intention as the weight values of the multiple resource types that correspond to the at least one named entity are sorted, and according to the weight values, searched multiple resources that correspond to the multiple resource types are sorted.

Optionally, the resource database includes multiple words and weight values of multiple resource types that correspond to each word in the multiple words.

Optionally, the searched resources are sorted according to a result of the user intention recognition includes: in a case in which at least one of the multiple words matches at least one of the multiple words in the resource database, a user intention as the weight values of the multiple resource types that correspond to the at least one word is recognized, and according to the weight values, searched resources that correspond to the resource types are sorted.

It should be understood that the specific implementation manners of the foregoing resource searching method are described in detail in the implementation manner of the exemplary server (as described above), and details are not described herein again. In addition, a person skilled in the art may select any one of the foregoing various implementation manners according to the present disclosure, or select a combination of the foregoing various implementation manners to configure a server, and other alternate implementation manners also fall into the protection scope of the present disclosure.

Using the method and the server for searching resource that are provided in the embodiments of the present disclosure can implement sorting, according to an intention of a user, all types of resources (including for example, resources like videos, apps, or audios, etc.) relevant to an entry entered by the user; for example, if the user expects video resources, then video resources may be ranked highest in a large amount of searched resources; in this way, the user can conveniently and quickly find resources that the user needs, thereby saving time as well as improving user experience to a great extent.

Correspondingly, an embodiment of this disclosure provides a non-transitory computer-readable storage medium, which stores computer executable instructions that, when executed by an electronic apparatus, cause the electronic apparatus to perform the resource searching method in any one of the foregoing method embodiments.

FIG. 4 is a schematic structural diagram of hardware of an electronic device for executing a resource searching method provided in an implementation manner of the disclosure. As shown in FIG. 4, the electronic device includes:

one or more processors 410 and a memory 420, with one processor 410 as an example in FIG. 4.

the electronic device for executing the resource searching method may further include: an input apparatus 430 and an output apparatus 440.

The processor 410, the memory 420, the input apparatus 430, and the output apparatus 440 can be connected by means of a bus or in other manners, with a connection by means of a bus as an example in FIG. 4.

As a non-transitory computer-readable storage medium, the memory 420 can be used to store non-transitory software programs, non-transitory computer-readable executable programs and modules, for example, a program instruction/module corresponding to the resource searching method in the embodiments of the disclosure (for example, the resource database 10 and the processing module 20 shown in FIG. 1). The processor 410 executes various functional disclosures and data processing of the server, that is, implements the resource searching method of the foregoing method embodiments, by running the non-transitory software programs, instructions, and modules stored in the memory 420.

The memory 420 may include a program storage area and a data storage area, where the program storage area may store an operating system and at least one disclosure needed by function; the data storage area may store data created according to use of the server, and the like. In addition, the memory 420 may include a high-speed random access memory, and also may include a non-volatile memory, such as at least one disk storage device, flash storage device, or other non-volatile solid-state storage devices. In some embodiments, the memory 420 optionally includes memories remotely disposed with respect to the processor 410, and the remote memories may be connected, via a network, to the server. Examples of the foregoing network include but are not limited to: the Internet, an intranet, a local area network, a mobile communications network, and a combination thereof.

The input apparatus 430 can receive entered digit or character information, and generate key signal inputs relevant to user setting and functional control of the server. The output apparatus 440 may include a display device, for example, a display screen, etc.

The one or more modules are stored in the memory 420, and execute the resource searching method in any one of the foregoing method embodiments when being executed by the one or more processors 410.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

1. A resource searching method applied in an electronic device, comprising:
performing a resource search and user intention recognition in a resource database according to an entry entered by a user; and
sorting searched resources according to a result of the user intention recognition.

2. The method according to claim 1, wherein the performing a resource search and user intention recognition in a resource database according to an entry entered by a user comprises:
segmenting, according to a word segmentation algorithm, the entry entered by the user into multiple words; and
performing the resource search and the user intention recognition according to the multiple words.

3. The method according to claim 2, wherein the resource database comprises multiple sensitive words and a resource type that corresponds to each sensitive word in the multiple sensitive words, wherein the sensitive word is a word identified with a resource type.

4. The method according to claim 3, wherein the sorting searched resources according to a result of the user intention recognition comprises:
in a case in which at least one of the multiple words matches at least one of the multiple sensitive words in the resource database, recognizing a user intention as a resource type that corresponds to the at least one sensitive word, and sorting searched resources that correspond to the resource type.

5. The method according to claim 4, wherein the resource database comprises multiple named entities and weight values of multiple resource types that correspond to each named entity in the multiple named entities, wherein the named entity is an entity that uses a name as an identifier.

6. The method according to claim 5, wherein the sorting searched resources according to a result of the user intention recognition comprises:
in a case in which at least one of the multiple words matches at least one of the multiple named entities in the resource database, recognizing a user intention as the weight values of the multiple resource types that correspond to the at least one named entity, and sorting, according to the weight values, searched multiple resources that correspond to the multiple resource types.

7. The method according to claim 6, wherein the resource database comprises multiple words and weight values of multiple resource types that correspond to each word in the multiple words.

8. The method according to claim 7, wherein the sorting searched resources according to a result of the user intention recognition comprises:
in a case in which at least one of the multiple words matches at least one of the multiple words in the resource database, recognizing a user intention as the weight values of the multiple resource types that correspond to the at least one word, and sorting, according to the weight values, searched resources that correspond to the resource types.

9.-16. (canceled)

17. An electronic device, comprising:
at least one processor; and
a memory in communication connection with the at least one processor, wherein
the memory stores instructions that can be executed by the at least one processor, and execution of the instructions by the at least one processor causes the at least one processor to:
perform a resource search and user intention recognition in the resource database according to an entry entered by a user; and sort searched resources according to a result of the user intention recognition.

18. The electronic device according to claim 17, wherein the instructions to perform resource search and user intention recognition in the resource database according to an entry entered by a user cause the at least one processor to:
segment, according to a word segmentation algorithm, the entry entered by the user into multiple words; and
perform the resource search and the user intention recognition according to the multiple words.

19. The electronic device according to claim 18, wherein the resource database comprises multiple sensitive words and a resource type that corresponds to each sensitive word in the multiple sensitive words, wherein the sensitive word is a word which can be identified with a resource type.

20. The electronic device according to claim 19, wherein the instructions to sort searched resources according to a result of the user intention recognition cause the at least one processor to:
in a case in which at least one of the multiple words matches at least one of the multiple sensitive words in the resource database, recognize a user intention as a resource type that corresponds to the at least one sensitive word, and sort searched resources that correspond to the resource type.

21. The electronic device according to claim 20, wherein the resource database comprises multiple named entities and weight values of multiple resource types that correspond to each named entity in the multiple named entities, wherein the named entity is an entity that uses a name as an identifier.

22. The electronic device according to claim 21, wherein the instructions to sort searched resources according to a result of the user intention recognition cause the at least one processor to:
in a case in which at least one of the multiple words matches at least one of the multiple named entities in the resource database, recognize a user intention as the weight values of the multiple resource types that correspond to the at least one named entity, and sort, according to the weight values, searched multiple resources that correspond to the multiple resource types.

23. The electronic device according to claim 22, wherein the resource database comprises multiple words and weight values of multiple resource types that correspond to each word in the multiple words.

24. The electronic device according to claim 23, wherein the instructions to sort searched resources according to a result of the user intention recognition causes the at least one processor to:
in a case in which at least one of the multiple words matches at least one of the multiple words in the resource database, recognize a user intention as the weight values of the multiple resource types that correspond to the at least one word, and sort, according to the weight values, searched resources that correspond to the resource types.

25. A non-transitory computer-readable storage medium, which stores computer executable instructions that, when executed by an electronic device, cause the electronic device to:
perform a resource search and user intention recognition in a resource database according to an entry entered by a user; and sorting searched resources according to a result of the user intention recognition.

26. The non-transitory computer-readable storage medium according to claim 25, wherein the instructions to perform resource search and user intention recognition in a resource database cause the electronic device to:
segment, according to a word segmentation algorithm, the entry entered by the user into multiple words; and
perform the resource search and the user intention recognition according to the multiple words.

27. The non-transitory computer-readable storage medium according to claim 26, wherein the resource database comprises multiple sensitive words and a resource type corresponding to each of the multiple sensitive words, wherein the sensitive word is a word capable of identifying a resource type.

28. The non-transitory computer-readable storage medium according to claim 27, wherein the instructions to sort searched resources according to a result of the user intention recognition cause the electronic device to:
in a case in which at least one of the multiple words matches at least one of the multiple sensitive words in the resource database, recognize a user intention as a resource type corresponding to the at least one sensitive word, and sort searched resources that correspond to the resource type.
